(19) United States
(12) Patent Application Publication
(10) Pub. No.: US 2022/0215080 A1
(43) Pub. Date: Jul. 7, 2022

(54) AUTHENTICATION DEVICE AND PROGRAM

(71) Applicant: KABUSHIKI KAISHA TOKAI RIKA DENKI SEISAKUSHO, Aichi (JP)

(72) Inventors: Kenji NARUMI, Aichi (JP); Mitsuo MORI, Aichi (JP)

(73) Assignee: KABUSHIKI KAISHA TOKAI RIKA DENKI SEISAKUSHO, Aichi (JP)

(21) Appl. No.: 17/609,232

(22) PCT Filed: Jan. 31, 2020
(86) PCT No.: PCT/JP2020/003733

§ 371 Date: Nov. 5, 2021

(30) Foreign Application Priority Data
Jun. 25, 2019 (JP) 2019-117001

(51) Int. Cl. G06F 21/32

(52) U.S. Cl. CPC G06F 21/32

(57) ABSTRACT

To achieve authentication without impairing the appearance of an installation target. There is provided an authentication device including an authentication unit configured to perform authentication based on input identification information, in which the authentication unit specifies, on the basis of the coordinates of an operation subject detected on an operation surface, input information corresponding to such coordinates, and performs authentication using the specified input information as the identification information.

### TECHNICAL FIELD

The present invention relates to an authentication device and a program.

### BACKGROUND ART

Recently, there has been widely used a device that performs authentication based on input identification information. Moreover, there has been developed an input device for inputting identification information. Some of such input devices are provided with a physical ten key, as disclosed in Patent Literature 1, for example.

### CITATION LIST

### Patent Literature

Patent Literature 1: JP 2009199581A

### SUMMARY OF INVENTION

### Technical Problem

However, the above-described input device having a physical input mechanism may impair the appearance depending on an installation place or target.

Therefore, in view of the above-described problem, the present invention aims at providing a new and improved authentication device and program capable of achieving authentication without impairing the appearance of an installation target.

### Solution to Problem

According to one aspect of the present invention, in order to solve the above-described problem, there is provided an authentication device including an authentication unit configured to perform authentication based on input identification information, in which the authentication unit specifies, on the basis of coordinates of an operation subject detected on an operation surface, input information corresponding to the coordinates, and performs authentication using the specified input information as the identification information.

According to another aspect of the present invention, to solve the above-described problem, there is provided a program controlling a computer to function as an authentication device including an authentication unit configured to perform authentication based on input identification information, in which the authentication unit specifies, on the basis of coordinates of an operation subject detected on an operation surface, input information corresponding to the coordinates, and performs authentication using the specified input information as the identification information.

### ADVANTAGEOUS EFFECTS OF INVENTION

According to the above-described present invention, it is possible to achieve authentication without impairing the appearance of an installation target.

### BRIEF DESCRIPTION OF DRAWINGS

FIG. 1 is a diagram illustrating a configuration example of an authentication system according to an embodiment of the present invention.

FIG. 2 is a diagram illustrating an example of an operation surface and an input interface according to the embodiment.

FIG. 3 is a diagram illustrating an example of the position relation among an operation surface, a detection unit, and a display unit according to the embodiment.

FIG. 4 is a diagram illustrating an example of the position relation among an operation surface, a detection unit, and a display unit according to the embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference signs, and repeated explanation thereof is omitted.

### 1. Embodiment

### 1.1. Overview

First, the overview of the present invention will be described. As described above, recently, there have been widely used devices that perform authentication based on input identification information and various input devices for inputting identification information. Moreover, some of such input devices are provided with a physical input mechanism such as a ten key, as disclosed in Patent Literature 1.

However, the above-described input devices having a physical input mechanism may considerably deteriorate the appearance depending on an installation target. For example, it is assumed that the authentication based on an input of identification information is applied to opening of a door of a mobile body such as a vehicle. In this case, the input device for inputting identification information is supposedly provided around a door. Because the external appearance of a mobile body such as a vehicle requires a design, the input device having a physical input mechanism may impair the appearance.

The technical ideas according to an embodiment of the present disclosure have been made in view of the above-described respects, and enable authentication without impairing the appearance of an installation target. For this, an authentication device 20 according to an embodiment of the present disclosure includes an authentication unit 210 that performs authentication based on input identification information. Moreover, the authentication unit 210 according to an embodiment of the present disclosure is characterized in specifying, on the basis of the coordinates of an operation subject detected on an operation surface, input information corresponding to the coordinates, and performing authentication using the specified input information as the identification information.

The following will specifically describe a configuration example of the authentication system 1 having the above-described characteristics.

### 1.2. Configuration Example

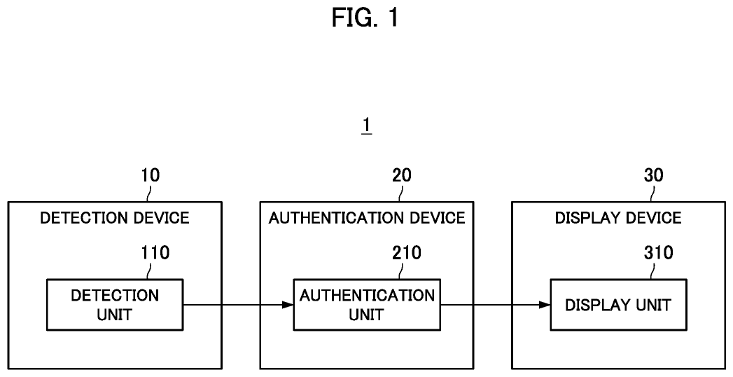

FIG. 1 is a diagram illustrating a configuration example of the authentication system 1 according to the embodiment. As illustrated in FIG. 1, the authentication system 1 of the embodiment includes, for example, a detection device 10, the authentication device 20, and a display device 30.

(Detection Device 10)

The detection device 10 of the embodiment includes a detection unit 110 that detects the coordinates of an operation subject for inputting identification information on an operation surface described later. Here, the operation subject of the embodiment indicates a subject brought into contact with the operation surface for the input of identification information. The operation subject of the embodiment may be, for example, user's finger, a pen for input, or the like.

Moreover, the detection unit 110 of the embodiment may capture images of the operation surface and the operation subject with a camera, for example, and detect the coordinates of the operation subject on the operation surface, on the basis of the acquired images. Meanwhile, the detection unit 110 of the embodiment may detect the coordinates of the operation subject using an infrared sensor or the like scanning the operation surface. Moreover, the detection unit 110 of the embodiment may be, for example, an electrostatic capacitance type or pressure-sensitive touch panel formed integrally with the operation surface.

(Authentication Device 20)

The authentication device 20 of the embodiment includes the authentication unit 210 that performs authentication based on input identification information. The authentication device 20 of the embodiment is characterized in specifying, on the basis of the coordinates of an operation subject detected on an operation surface by the detection unit 110, input information corresponding to the coordinates, and performing authentication using the specified input information as the identification information.

Examples of the identification information of the embodiment include numbers, various characters including alphabets, symbols/marks, pictures, or the combination of these, and the like. For example, in the case where the identification information is a predetermined character string, the authentication unit 210 of the embodiment specifies, on the basis of the detected coordinates of an operation subject, characters (input information) based on such coordinates, and performs authentication on the basis of a character string (identification information) formed by the combination of the specified characters. Moreover, the identification information of the embodiment may be a specific gesture. In this case, the authentication unit 210 may perform authentication using a gesture discriminated from the detected coordinates of an operation subject.

Moreover, when the input identification information matches the predetermined information, the authentication unit 210 of the embodiment may perform a control for opening an opening/closing mechanism of various doors. For example, in the case where the authentication system 1 of the embodiment is applied to a mobile body such as a vehicle, the authentication unit 210 is able to open the door of the mobile body on the basis of the match of the input identification information.

With the above-described function of the authentication unit 210 of the embodiment, empty-handed opening of the opening/closing mechanism is possible without using a physical key in a conventional manner, which considerably improves the usability of a user.

Moreover, the authentication unit 210 of the embodiment may perform the above-described authentication based on identification information together with or instead of biometric authentication. Examples of such biometric authentication include face authentication, iris authentication, fingerprint authentication, vein authentication, and the like. For example, if both the authentication based on input identification information and the biometric authentication are performed together, it is possible to achieve securer authentication.

Meanwhile, in the above-described biometric authentication, there may also assumed a case where the accuracy of authentication is reduced depending on a user or environments at the time of authentication. For example, in the case of fingerprint authentication, injuries, dryness, or the like may make read-out of fingerprints difficult. Moreover, in the case of face authentication, for example, if condensation, freezing, dirt, or the like is occurred on a lens of a camera or the like, it is not possible to correctly capture an image of user's face, which supposedly impairs the accuracy of authentication considerably.

Therefore, in the authentication system 1 of the embodiment, when the biometric authentication has failed, the above-described authentication based on identification information may be performed to improve the accuracy of authentication as a whole. With such a control, even in a situation requiring urgent evacuation into a mobile body such as when a snow storm is occurred, for example, it is possible to secure the safety of a user. Note that the authentication unit 210 may dynamically control whether both the biometric authentication and the above-described authentication based on identification information are performed together and the priority, in accordance with surrounding environments.

(Display Device 30)

The display device 30 of the embodiment includes a display unit 310 that displays, on the operation surface, an input interface for inputting identification information. The authentication unit 210 of the embodiment may specify, on the basis of the coordinates of an operation subject detected by the detection unit 110, input information corresponding to such coordinates on the input interface displayed on the operation surface by the display unit 310.

The display unit 310 of the embodiment may be, for example, a projector projecting the above-described input interface on the operation surface. Moreover, for example, the display unit 310 of the embodiment may be various kinds of displays formed integrally with the operation surface.

The above has described a configuration example of the authentication system 1 of the embodiment. Note that the configuration described above using FIG. 1 is an example and the configuration of the authentication system 1 of the embodiment is not limited thereto. For example, as described later, the input interface of the embodiment may not be necessarily displayed on the operation surface. The input interface of the embodiment may virtually exist on space with a form not recognized visually by a user. In this case, the authentication system 1 may not include the display device 30. The configuration example of the authentication system 1 of the embodiment may be modified flexibly in accordance with specifications and operations.

### 1.3. Application Example

The following will concretely describe an application example of the authentication system 1 of the embodiment. The following will describe an example of the case where the authentication system 1 of the embodiment is used to open the door of a mobile body such as a vehicle.

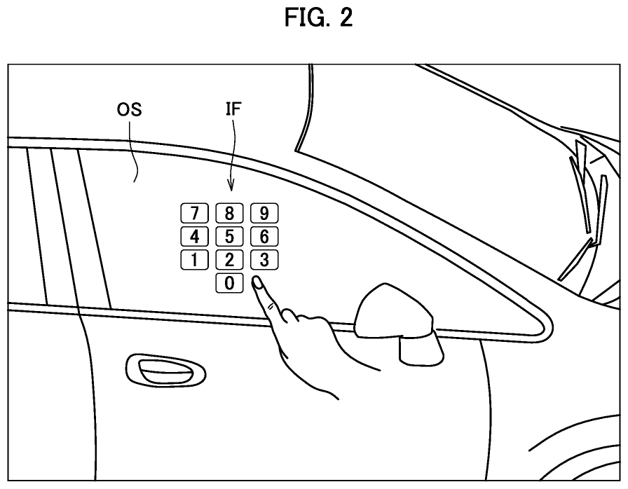

FIG. 2 is a diagram illustrating an example of an operation surface and an input interface according to the embodiment. The operation surface of the embodiment may be provided in a part of the external configuration of a mobile body, for example. In the example illustrated in FIG. 2, an operation surface OS is provided at a side glass of the mobile body, and an input interface IF for inputting numbers 0 to 9 is displayed on the operation surface OS.

In this case, a user may input the predetermined combination of numbers using an operation subject such as a finger and the input interface IF. Here, when the input identification information matches the predetermined character string, the authentication unit 210 performs a control for opening the door of the mobile body.

Note that in the case where the operation surface OS is provided on the side glass of the mobile body, the display unit 310 may project the input interface IF on the side glass from the outside of the mobile body, for example, as illustrated in FIG. 2.

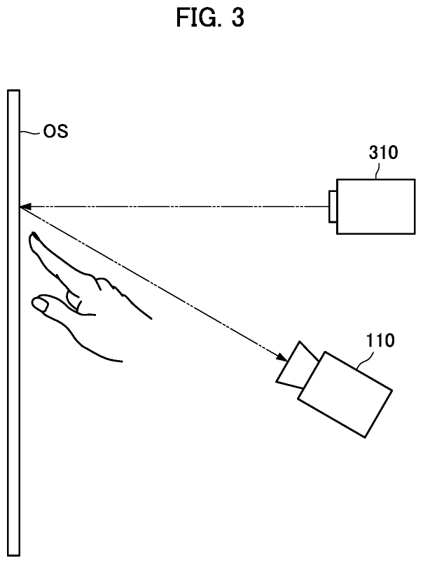

FIG. 3 is a diagram illustrating an example of the position relation among the operation surface OS, the detection unit 110, and the display unit 310 according to the embodiment. As illustrated in FIG. 3, the detection unit 110 and the display unit 310 of the embodiment may be arranged on the side where a user performs an input operation on the operation surface OS, that is, the outside of the mobile body such as on a side mirror, for example.

In this case, the display unit 310 projects the input interface IF on the operation surface OS provided on the side glass or the like from the outside of the mobile body such as on a side mirror. Moreover, the detection unit 110 may capture images of the input interface IF and the operation subject from the outside of the mobile body, and detect the coordinates of the operation subject on the input interface IF on the basis of the position relation.

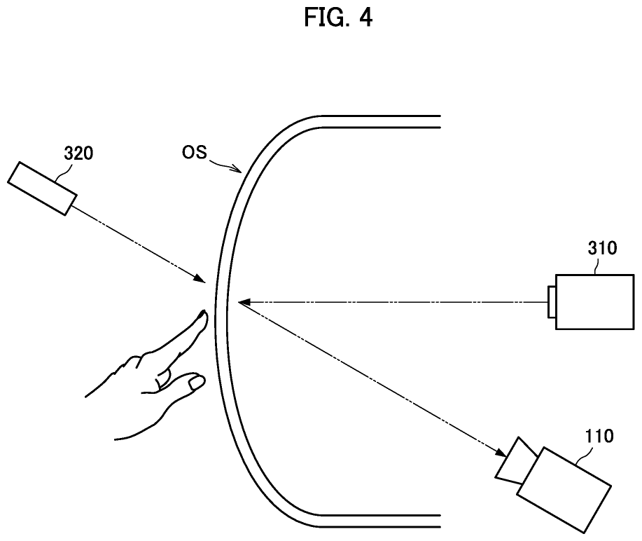

Meanwhile, the detection unit 110 and the display unit 310 of the embodiment may be arranged on the opposite side of the side where a user performs an input operation on the operation surface OS. In the case of an example illustrated in FIG. 4, the operation surface OS is provided on the side mirror, and the detection unit 110 and the display unit 310 are arranged inside the side mirror.

In this case, an area on the side mirror where the input interface IF is projected may be formed using transparent liquid crystal. The display unit 310 makes the transparent liquid crystal clouded by applying a voltage, so as to project the input interface IF thereon. Moreover, in this case, the detection unit 110 is able to detect, on the basis of a captured image of a shadow of the operation subject on the input interface IF, the coordinates of such an operation subject. Note that in the case where it is difficult to capture an image of a shadow of the operation subject only with natural light, a light emitting unit 320, provided on the same side as the operation subject, may be used to emit light to the direction of the input interface IF.

Note that the above-described cloudness using the transparent liquid crystal is not necessarily required, and the detection unit 110 is also able to detect a contact of the operation subject (a finger) on the operation surface OS on the basis of the change in shape or color of a finger surface when pressing the operation OS made of a transparent material, for example.

The above has described, using the concrete examples, the position relation among the operation surface OS, the detection unit 110, and the display unit 310 of the embodiment. Note that the display unit 310 of the embodiment may display the input interface IF on the operation surface when the detection unit 110 has detected a user existing in the vicinity of the operation surface OS or a contact of the operation subject on the operation surface OS, for example.

In the authentication system 1 of the embodiment, it is not necessary to arrange the input device such as a ten key having a physical input mechanism on the external appearance of the mobile body, thereby enabling authentication without impairing the appearance of the mobile body.

Note that although the above has exemplified the case where the display unit 310 of the embodiment displays the input interface IF on the operation surface OS and the detection unit 110 detects the coordinates of the operation subject on the input interface IF, the input interface IF of the embodiment may not be necessarily displayed on the operation surface OS.

The authentication unit 210 of the embodiment may be also able to specify input information on the basis of the relative position of the coordinates of the operation subject on the operation surface OS that are detected by the detection unit 110. For example, the authentication unit 210 of the embodiment may specify, with the coordinates of the operation subject detected first by the detection unit 110 as a reference, input information corresponding to the coordinates of the operation subject detected later.

As a concrete example, the authentication unit 210 may specify input information corresponding to the vicinity of the coordinates of the operation subject detected first, as “5” as illustrated in the vicinity of the center of the input interface IF in FIG. 2, and thereafter specify input information as “8” when the detected coordinates of the operation subject are positioned on the upper side of the coordinates detected first, as “4” when the detected coordinates of the operation subject are positioned on the left side of the coordinates detected first, or as “6” when the detected coordinates of the operation subject are positioned on the right side of the coordinates detected first.

With the above-described control, it is possible to specify identification information input by a user without displaying the input interface IF, and construct the authentication system 1 with an easier configuration. Moreover, with the above-described control, even when a third party has peeked the input of identification information by a user, it is possible, with no display of the input interface IF, to effectively reduce the probability that the identification information is leaked to the third party and achieve securer authentication.

The above has specifically described the functions of the authentication system 1 of the embodiment. Note that although the above has described the case where the authentication system 1 of the embodiment is applied to opening of the door of the mobile body, the range of application of the authentication system 1 of the embodiment is not limited to such an example.

The authentication system 1 of the embodiment may be widely applied to targets having an opening/closing mechanism, such as a door, a locker, or a home delivery box that are provided in buildings, for example. The authentication system 1 of the embodiment is able to achieve authentication without impairing the appearance of such targets.

### 2. Summary

As described above, the authentication device 20 according to an embodiment of the present disclosure includes the authentication unit 210 that performs authentication based on input identification information. Moreover, the authentication unit 210 according to an embodiment of the present disclosure is characterized in specifying, on the basis of the coordinates of an operation subject detected on an operation surface, input information corresponding to such coordinates, and performing authentication using the specified input information as the identification information. With such a configuration, it is possible to achieve authentication without impairing the appearance of an installation target.

Heretofore, preferred embodiments of the present invention have been described in detail with reference to the appended drawings, but the present invention is not limited thereto. It is obvious that a person skilled in the art can arrive at various alterations and modifications within the scope of the technical ideas defined in the claims, and it should be naturally understood that such alterations and modifications are also encompassed by the technical scope of the present invention.

The effects described in the present specification are merely explanatory or representatives and are not restrictive. That is, the technologies of the present disclosure can exert other effects, in addition to or instead of the above-described effects, that are clear for a person skilled in the art on the basis of the description in the present specification.

Moreover, it is also possible to form a program controlling a hardware such as a CPU, a ROM, and a RAM in a computer to achieve the functions equivalent to those of the components of the control device 20, and it is also possible to provide a non-transitory computer readable storage medium recording such a program.

### REFERENCE SIGNS LIST

1 authentication system

10 detection device

110 detection unit

20 authentication device

210 authentication unit

30 display device

310 display unit

1. An authentication device, comprising:
an authentication unit configured to perform authentication based on input identification information, wherein
the authentication unit specifies, on the basis of coordinates of an operation subject detected on an operation surface, input information corresponding to the coordinates, and performs authentication using the specified input information as the identification information.

2. The authentication device according to claim 1, wherein the authentication unit specifies, on the basis of the coordinates of the operation subject detected on an input interface displayed on the operation surface, the input information corresponding to the coordinates.

3. The authentication device according to claim 2, wherein
the input interface is projected on the operation surface, and
the coordinates of the operation subject on the input interface are detected on the basis of a captured image of the interface and the operation subject.

4. The authentication device according to claim 1, wherein the authentication unit performs authentication based on the identification information together with biometric authentication or instead of the biometric authentication.

5. The authentication device according to claim 1, wherein
the identification information is a predetermined character string, and
the authentication unit performs a control for opening an opening/closing mechanism when the identification information matches a predetermined character string.

6. The authentication device according to claim 5, wherein
the operation surface is provided in a part of an external configuration of a mobile body, and
the authentication unit performs a control for opening a door of the mobile body when the authentication has succeeded.

7. A non-transitory computer readable storage medium storing a program, the program, controlling a computer to function as:
an authentication device that includes
an authentication unit configured to perform authentication based on input identification information, wherein
the authentication unit specifies, on the basis of coordinates of an operation subject detected on an operation surface, input information corresponding to the coordinates, and performs authentication using the specified input information as the identification information.
